(19) United States
(12) Patent Application Publication
(10) Pub. No.: US 2026/0061924 A1
(43) Pub. Date: Mar. 5, 2026

(54) ROOF RAIL DEPLOYABLE UTILITY BOOM

(71) Applicant: Toyota Motor Engineering & Manufacturing North America, Inc., Plano, TX (US)

(72) Inventors: Paxton S. Williams, Milan, MI (US); Scott Louis Frederick, Brighton, MI (US); Ryan C. Harris, Saline, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/822,747

(22) Filed: Sep. 3, 2024

(51) Int. Cl. B60P 1/54

(52) U.S. Cl. CPC B60P 1/5409

(57) ABSTRACT

A vehicle utility boom assembly includes a first roof rail including a first boom passage, a second roof rail including a second boom passage and structured to be mounted opposite the first roof rail, a boom housing structured to connect the first and second boom passages, and a boom structured to be positionable in the housing so as to be deployable from the housing along a side of the vehicle, through any of the first and second boom passages. The boom may be retracted into the boom housing for compactness and concealment when not in use. The boom is deployable from the housing to a side of the vehicle, to support objects above a ground surface adjacent the vehicle.

### TECHNICAL FIELD

The subject matter described herein relates to vehicles and, more particularly, to a roof-mounted utility boom assembly structured for supporting an object above a ground surface along a side of a vehicle.

### BACKGROUND

While camping or engaged in other activities in parks or recreational areas, vehicle users may wish to employ various accessories for comfort and enjoyment. For example, a user may wish to set up a hammock to relax, or suspend a small personal tent above ground level. For reasons of convenience, it may also be desirable to locate any supported accessory as close to a vehicle as possible. However, it may be difficult to find a tree or other object with branches or other attachment characteristics suitable for supporting or suspending such accessories. Also, it may be impossible or impractical to park a vehicle close to an object with suitable attachment characteristics.

### SUMMARY

In one aspect of the embodiments described herein, a vehicle utility boom assembly includes a first roof rail including a first boom passage, and a second roof rail including a second boom passage and structured to be mounted opposite the first roof rail. A boom housing is structured to connect the first and second boom passages. A boom is structured to be positionable in the housing so as to be deployable from the housing along a side of the vehicle, through any of the first and second boom passages.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is a schematic perspective view of a vehicle incorporating a utility boom assembly in accordance with an embodiment described herein, showing a boom of the utility boom assembly in a stowed or retracted configuration.

FIG. 1A is a schematic side view of an end portion of a boom in accordance with an embodiment described herein, including a hook portion for supporting an object and a hole provided for connection to a boom supporting element.

FIG. 2 is the schematic perspective view of FIG. 1, illustrating options for deploying the boom to either the right-hand or left-hand side of the vehicle.

FIG. 3 is the schematic perspective view of FIG. 2, showing the boom deployed to a right-hand side of the vehicle and supported by an optional boom supporting element to enable suspension of relatively heavier loads by the deployed boom.

FIG. 4 is a schematic front view of the vehicle of FIG. 3, shown supporting a one-person tent above a ground surface.

FIG. 5 is the schematic perspective view of the vehicle of FIG. 3, showing a ratchet mechanism coupled to the boom supporting element to enable greater control of tensioning of the boom supporting element and/or elevation of a deployed free end of a segmented boom.

FIG. 6 is the schematic perspective view of the vehicle of FIG. 3, showing a segmented version of the boom deployed to a right-hand side of the vehicle.

FIG. 6A is a schematic cross-sectional view of a non-deployed portion of the boom of FIG. 6 residing in a boom housing and incorporating an embodiment of an anti-rotation mechanism structured to prevent undesired rotation of the deployed portion of the segmented boom.

### DETAILED DESCRIPTION

Embodiments described herein relate to a vehicle utility boom assembly including a first roof rail including a first boom passage, a second roof rail including a second boom passage and structured to be mounted opposite the first roof rail, a boom housing structured to connect the first and second boom passages, and a boom structured to be positionable in the housing so as to be deployable from the housing along a side of the vehicle, through any of the first and second boom passages. The boom may be retracted into the boom housing for compactness and concealment when not in use. The boom is deployable from the housing to a side of the vehicle, to support objects above a ground surface adjacent the vehicle. An amount that the deployed boom extends from the vehicle may be varied by a user as needed to support objects (or portions of objects) at various distances from the vehicle and also at various heights with respect to a ground surface.

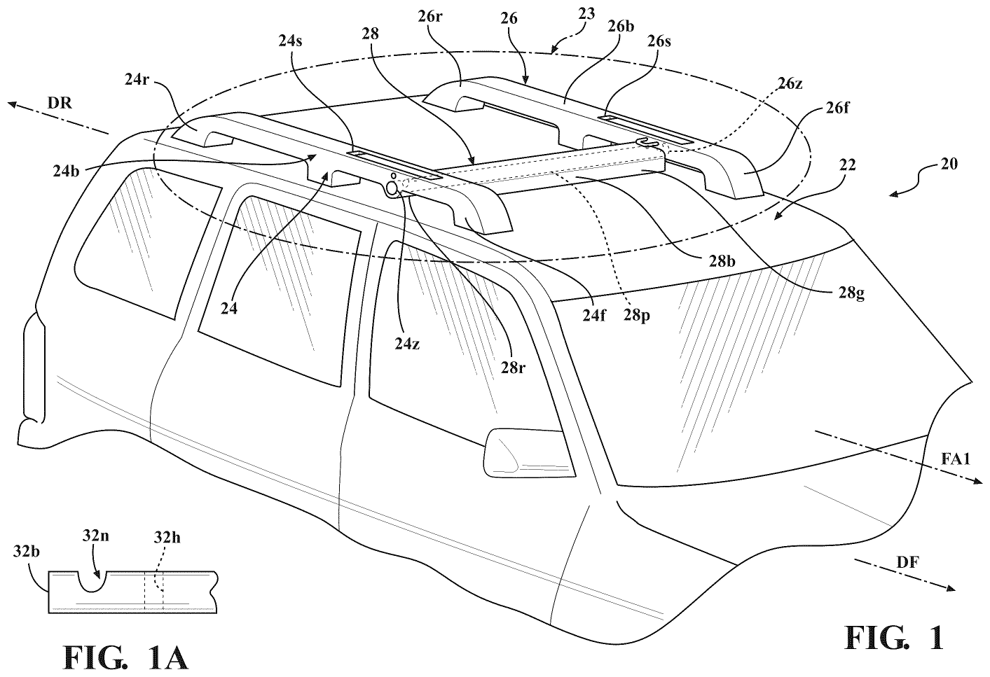

FIG. 1 is a schematic perspective view of a vehicle 20 incorporating a utility boom assembly 23 in accordance with an embodiment described herein. As used herein, a “vehicle” is any form of motorized transport. In one or more implementations, the vehicle 20 is conventionally-powered or hybrid passenger vehicle. While arrangements will be described herein with respect to passenger vehicles, it will be understood that embodiments are not limited to passenger vehicles. In some implementations, the vehicle 20 may be any form of motorized transport that benefits from the functionality discussed herein.

Some of the possible elements of the vehicle 20 are shown in FIG. 1 and will be described with reference thereto. Additionally, it will be appreciated that for simplicity and clarity of illustration, where appropriate, reference numerals may have been repeated among the different figures to indicate corresponding or analogous elements. Also, in the drawings referenced herein, similar reference characters may refer to similar features shown in different views. In addition, the discussion outlines numerous specific details to provide a thorough understanding of the embodiments described herein. Those of skill in the art, however, will understand that the embodiments described herein may be practiced using various combinations of these elements.

The vehicle 20 may have a roof 22 extending over an occupant compartment of the vehicle. The roof 22 may be structured to support a predetermined amount of external loading thereon, to enable items to be attached to the roof and/or carried on the roof. For example, racks or roof rails as described herein may be secured to the roof 22 to enable objects such as camping equipment, bicycles, etc. to be attached to the roof 22 for transport.

The vehicle 20 shown in FIG. 1 includes an embodiment 23 of a utility boom assembly attached to the roof 22. Embodiments of the utility boom assembly 23 may be structured to support or suspend an object located along a side of the vehicle 20 and spaced apart from the vehicle above a ground surface on which the vehicle 20 resides. The various elements of the boom assembly 23 may be formed from any material or materials suitable for the purposes described herein.

In one or more arrangements, the utility boom assembly 23 may include a first roof rail 24 mounted to the roof 22 adjacent an associated first side of the vehicle. In the embodiments shown in the drawings, the first side is a right-hand side of the vehicle 20, the first roof rail 24 is a rail mounted adjacent the first (i.e., right-hand) side of the vehicle, and the second side of the vehicle is a left-hand side of the vehicle 20 with a second roof rail 26 (described below) mounted adjacent the second (i.e., left-hand) side of the vehicle 20. However, since embodiments of the utility boom assembly may operate in the manner described herein whether a boom is deployed on either the right-hand side or the left-hand side of the vehicle 20, the “first side” could alternatively be the left-hand side of the vehicle 20 and the “second side” could be the right-hand side of the vehicle 20.

First roof rail 24 may be structured to extend parallel to a fore-aft axis FA1 of the vehicle 20 when the first roof rail 24 is mounted on the vehicle roof 22. The first roof rail 24 may include a body 24b, a forward end 24f extending from the body 24b toward a front direction DF of the vehicle 20, and a rear end 24r extending from the body 24b toward a rearward direction DR of the vehicle 20. A first support-receiving cavity 24s may be formed in the first roof rail 24. A length dimension of the support-receiving cavity 24s may extend along a longitudinal or fore-aft extent of the first roof rail 24 (i.e., parallel to the vehicle fore-aft axis FA1). The support-receiving cavity 24s may be structured to receive therein a first boom support post 44 (described in greater detail below). A first boom passage 24z may extend across a width dimension of the first roof rail 24 (i.e., a dimension extending perpendicular to the length dimension of the support-receiving cavity 24s and to the vehicle fore-aft axis FA1). The first boom passage 24z may be a through-passage structured to receive therein a first end 28r of a boom housing 28 (described in greater detail below), to enable attachment and securement of the boom housing first end 28r to the first roof rail 24.

The utility boom assembly 23 may include a first boom support post 44 structured to be connected to the first roof rail 24 in a support configuration of the first boom support post 44. In one or more arrangements, the first boom support post 44 may include a first end 44a and a second end 44b opposite the first end 44a.

A “support configuration” of a boom support post is a configuration of the support post structured to enable a portion of a load acting on a boom to be transferred from the boom to the support post and a roof rail supporting the support post, by using a boom support element as described herein. The support configuration of the boom support post may also enable a portion of the load acting on a boom to be transferred to another roof rail and/or the boom housing via the boom support element. This may enable the support of relatively heavier loads by the boom.

As used herein, the term “connected” refers to both direct physical contact between elements and indirect connections between the elements (i.e., through one or more intermediate parts interposed between the elements). For the support post structure shown in the drawings, the support configuration may be a configuration in which the support post is connected to the roof rail so as to extend in a vertical or substantially vertical orientation from the roof rail, and so that a portion of the support post resides above a level of the housing and the first and second roof rails. In one or more arrangements, a boom support post may be attached to an associated roof rail and positioned in its support configuration by inserting an end of the support post into a complementary support-receiving cavity formed in the roof rail so that the support post extends vertically or substantially vertically from the cavity.

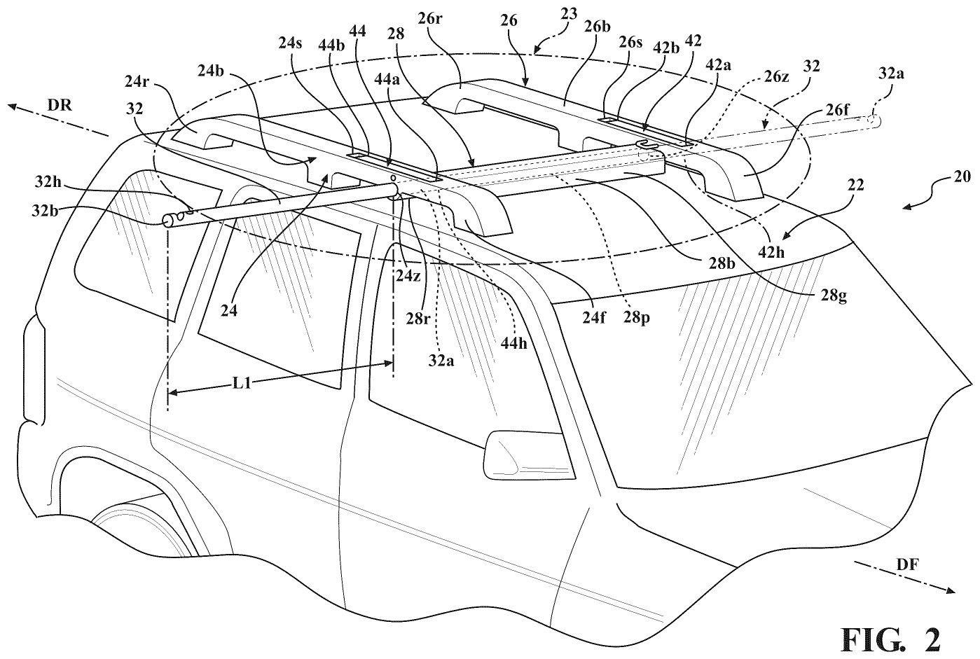

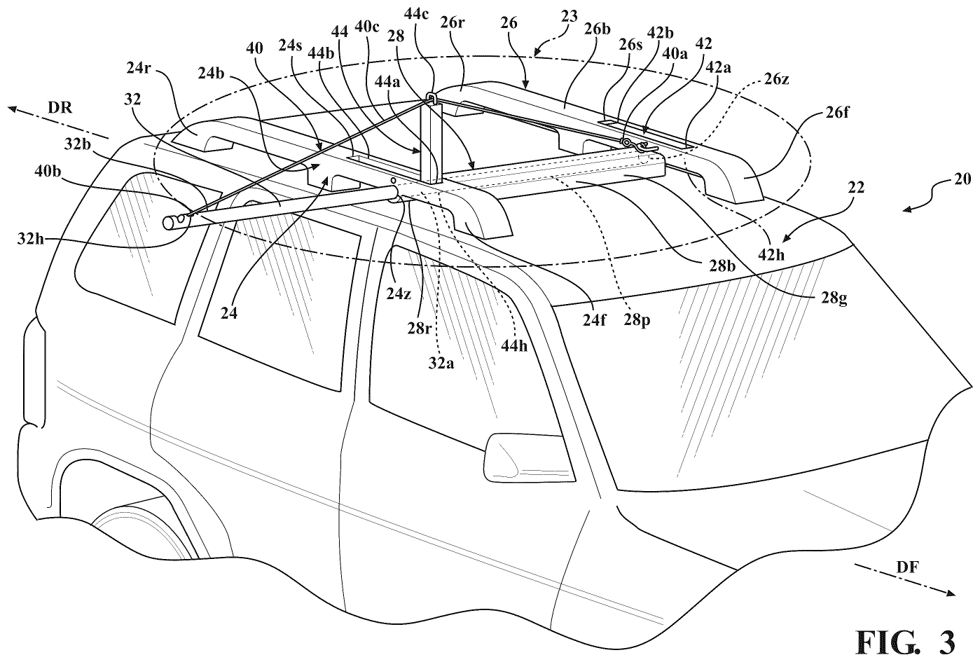

In one or more particular arrangements, the first boom support post 44 is rotatably attached to the first roof rail 24 so as to be rotatable between a stowed configuration (shown in FIGS. 1 and 2) in which the first boom support post 44 resides inside the first support-receiving cavity 24s, and the support configuration (as shown in FIG. 3) in which a portion of the first boom support post 44 extends outside the first support-receiving cavity 24s. A “stowed configuration” is a configuration of a boom support post in which the support post is not in use for transferring a portion of the load on the boom. In one or more arrangements, as shown in FIGS. 1 and 2, the first boom support post 44 resides entirely inside the first support-receiving cavity 24s when the first boom support post 44 is in its stowed configuration.

In one or more arrangements, the utility boom assembly 23 may also include a second roof rail 26 structured to be mounted to the roof 22 opposite the first roof rail 24. Second roof rail 26 may be structured to extend parallel to the vehicle fore-aft axis FA1 (and also parallel to first roof rail 24) when the second roof rail 26 is mounted on the vehicle roof 22. In the embodiments shown in the drawings, the second roof rail 26 is a left-side rail (i.e., a rail mounted to the roof 22 adjacent a left-hand side of the vehicle). The second roof rail 26 may include a body 26b, a forward end 26f extending from the body 26b toward the front end of the vehicle 20, and a rear end 26r extending from the body 26b toward the rear end of the vehicle 20.

A support-receiving cavity 26s may be formed in the second roof rail 26. A length dimension of the support-receiving cavity 26s may extend along a longitudinal or fore-aft extent of the second roof rail 26 (i.e., parallel to the vehicle fore-aft axis FA1). The cavity 26s may be structured to receive therein a second boom support post 42 (described in greater detail below).

A second boom passage 26z may extend across a width dimension of the second roof rail 26 (i.e., a dimension extending perpendicular to the length dimension of the support-receiving cavity 24s and to the vehicle fore-aft axis FA1). The second boom passage 26z may be a through-passage structured to receive therein a second end 28g of the boom housing 28, to enable attachment and securement of the boom housing second end 28g to the second roof rail 26.

In one or more arrangements, the first roof rail 24 and the second roof rail 26 may be structured so that, when the rails 24, 26 are mounted on the vehicle roof 22 and the first boom passage 24z and the second boom passage 26z are aligned with each other and connected by the boom housing 28, a boom 32 received in the housing 28 may be deployable so that a centroidal axis CA1 of a cross-section of the unloaded boom 32 extends horizontally or substantially horizontally (i.e., within ±5°) of a horizontal plane passing through the centroidal axis) when the boom is extended outside the housing 28 and the first and second boom passages.

The utility boom assembly 23 may also include a second boom support post 42 structured to be connected to the second roof rail 26 in a support configuration of the second boom support post 42. In one or more2arrangements, the second boom support post 42 may include a first end 42a and a second end 42b opposite the first end 42a.

In one or more particular arrangements, the second boom support post 42 is rotatably attached to the second roof rail 26 so as to be rotatable between a stowed configuration (as shown in FIGS. 1 and 2 for the first boom support post 44) in which the second boom support post 42 resides inside the second support-receiving cavity 26s, and a support configuration of the second boom support post 42 (as shown in FIG. 3) in which a portion of the second boom support post 42 extends outside the second support-receiving cavity 26s.

The utility boom assembly 23 may include a boom housing 28 structured to hold a boom when the boom is not in use and to support an end of the boom therein when the boom is deployed to either side of the vehicle 20. The boom housing 28 may be in the form of a hollow tube having a cylindrical, rectangular or other cross-sectional shape depending on the projected loading requirements of a particular application. In one or more arrangements, the boom housing 28 may have a body 28b, a first side end 28r extending from the body 28b, and a second side end 28g extending from the body opposite the first side end 28r. In the embodiments shown herein, the first side end 28r is a right-side end and the second side end 28g is a left side end. body 28b, first side end 28r and second side end 28g may, in combination, define an open-ended interior passage 28p structured to receive the boom 32 therein and enable the boom to be deployed to any of the right side and the left side of the vehicle 20, depending on user requirements.

The utility boom assembly may include a boom 32 structured to be deployable to support or suspend an object located along a side of the vehicle 20. The boom 32 may be structured to be positionable in the housing 28 so as to be deployable from the housing along a side of the vehicle 20, through any of the first and second boom passages 24z, 26z. The term “deployable” means that the boom 32 is movable so that a deployed end of the boom extends a distance from an associated one of the first and second boom passages 24z, 26z, to enable an object to be supported from the boom 32 at a location spaced apart from the vehicle 20. The boom 32 may be formed from a hollow tube, such as a metal or polymeric tube, for example. FIG. 1 shows the boom 32 in a stowed or retracted condition inside the housing 28 for periods when the boom 32 is not in use.

The boom 32 may be structured to be removable from housing 28. In some arrangements, the boom 32 may be structured so that the entire boom 32 fits into the housing 28 when the boom 32 is not in use. The boom 32 may be structured to be slidable within housing 28 and to be deployable to any of the left and right sides of the vehicle 20. The boom 32 may have a cylindrical, rectangular or other cross-sectional shape designed to slidably fit within housing 28.

In one or more arrangements, boom 32 may have a first end 32b and a second end 32a positioned opposite the first end 32b. Referring to FIG. 1A, the first and second ends 32b and 32a of the boom 32 may each have a hook portion 32n formed therein and structured to facilitate hanging of an object from the boom 32 when the boom is deployed. Each of the ends 32a and 32b of the boom 32 may also have a through hole 32h formed therein. Holes 32h may be structured to enable a cable, rope, hook and/or other attachment structure of a boom supporting element 40 (described in greater detail below) to be secured to any end of the boom 32. Alternative hooking and boom supporting element connection structures may also be used.

The distance a deployed end of the boom 32 extends from the housing 28 and/or an associated one of first and second boom passages 24z, 26z may be determined by user preferences and the requirements of a particular support application. for example, FIG. 2 is the schematic perspective view of FIG. 1, illustrating options for deploying the boom 32 to either the right-hand (shown in solid lines) or left-hand side (shown in phantom lines) of the vehicle 20. FIG. 2 shows end 32b of boom 32 extending a distance L1 from the first boom passage 24z, thereby enabling the extended boom 32 to support an object to be positioned on a right side of the vehicle 20. However, the boom 32 could alternatively be deployed the same distance L1 from the second boom passage 26z, to enable the extended boom 32 to support an object to be positioned on a left side of the vehicle 20.

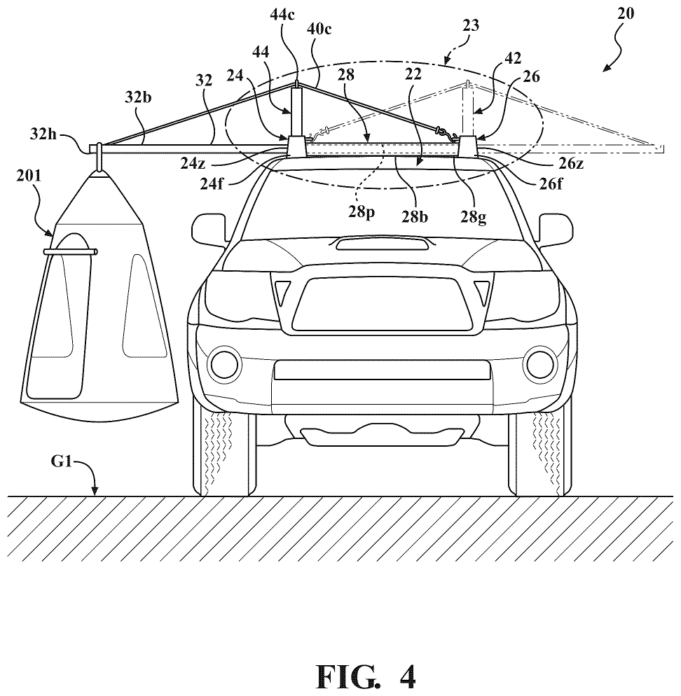

Referring to FIGS. 3-5, the utility boom assembly 23 may further include a boom supporting element 40 structured to extend between the support boom 32 and the first boom support post 44, and between the first boom support post 44 and either of the housing 28 and the second roof rail 26, when the boom 32 is deployed along a first side of the vehicle 20. FIG. 3 is the schematic perspective view of FIG. 2, showing the boom 32 deployed to a right-hand side of the vehicle and supported by an optional boom supporting element 40 to enable suspension of relatively heavier loads by the deployed boom. In an exemplary application of the boom assembly 23, FIG. 4 is the schematic front view of the vehicle of FIG. 3, shown supporting a one-person tent above a ground surface G1.

In one or more arrangements, the boom supporting element 40 may be in the form of a cable or strap having a first end 40b attachable to the boom 32, a second end 40a opposite the first end 40b and attachable to the housing 28 or to the second roof rail 26, and an intermediate portion 40c extending between the first and second ends 40b, 40a. The intermediate portion 40c may be slidably connectible to either of boom support posts 42, 44 (i.e., the intermediate portion 40c may be connectible to either of boom support posts 42, 44 so as to be slidable with respect to the boom support). slidable connection of the boom supporting element 40 to a boom support post may enable the boom supporting element 40 to be “reeled in” or otherwise shortened to adjust the tension in the boom supporting element 40 and to secure a segmented version of the boom (described in greater detail below) to be supported and maintained at a desired angle O with respect to a horizontal plane (such as horizontal plane H1). slidable connection of the boom supporting element 40 to a boom support post may be effected by a loop or bracket applied to the boom support post (such as loop 44c on support post 44) to attach the boom supporting element 40 to the support post while enabling the boom supporting element 40 to slide with respect to the boom support post. Other connection methods may also be used.

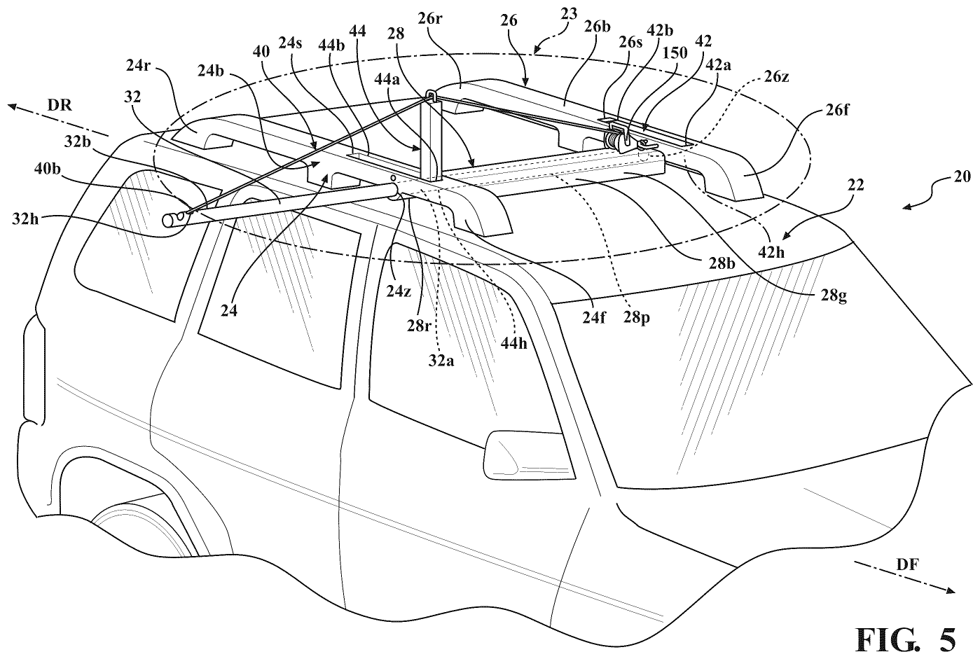

FIG. 5 is the schematic front view of the vehicle of FIG. 3, with a ratchet mechanism coupled to the boom supporting element 40 to enable greater control of tensioning of the boom supporting element and/or elevation of a deployed free end of a segmented boom. Referring to FIG. 5, in particular arrangements, the boom supporting element 40 is connected to one of the housing 28 and the second roof rail 26 by a known ratchet mechanism 150 including, for example, a rotatable ratchet and a spring-loaded pawl (not shown in detail). In a known manner, the ratchet may be rotated to extend or retract a boom supporting element 40 wound around the ratchet to achieve a desired tension and/or extended length of the boom supporting element 40, and the pawl may maintain the desired extended length and tension of the boom supporting element 40.

Operation of embodiments of the utility boom assembly will now be described, with reference to the drawings.

FIG. 1 shows the boom 32 in a stowed or non-deployed condition, received within housing 28. FIG. 2 shows the boom 32 deployed to the right-hand side of the vehicle 20. However, the boom 32 could alternatively be deployed to the opposite or left-hand side of the vehicle 20 as shown in phantom in FIG. 2.

To deploy the boom 32, the boom may be manually removed from housing 28 to the extent desired by a user, while leaving enough of the boom 32 inside the housing 28 to support the extended portion of the boom in cantilever fashion. An object 201 may then be hung from the boom at a selected distance from the vehicle 20 as shown in FIG. 4.

Referring to FIG. 3, if additional support is required for suspending a heavier object (or for suspending a relatively lighter object farther from the vehicle 20), the boom 32 may be deployed as previously described. Then, an end of the first boom support post 44 (if the first boom support post 44 is not connected to the first roof rail 24) may be inserted into the first roof rail support-receiving cavity 24s so as to extend from the cavity in the support configuration of the support post. If the first boom support post 44 is rotatably connected to the first roof rail 24, the first boom support post 44 may be rotated from the cavity 24s into the support configuration as shown in FIGS. 2-3. Then, the boom supporting element 40 may be connected to the deployed end of the boom 32, then connected to the first boom support post 44, then connected to one of the housing 28 and the second roof rail 26 as previously described, while adjusting and maintaining the tension in the boom supporting element 40 to provide the desired support for the object 201 to be suspended from the boom (FIG. 4).

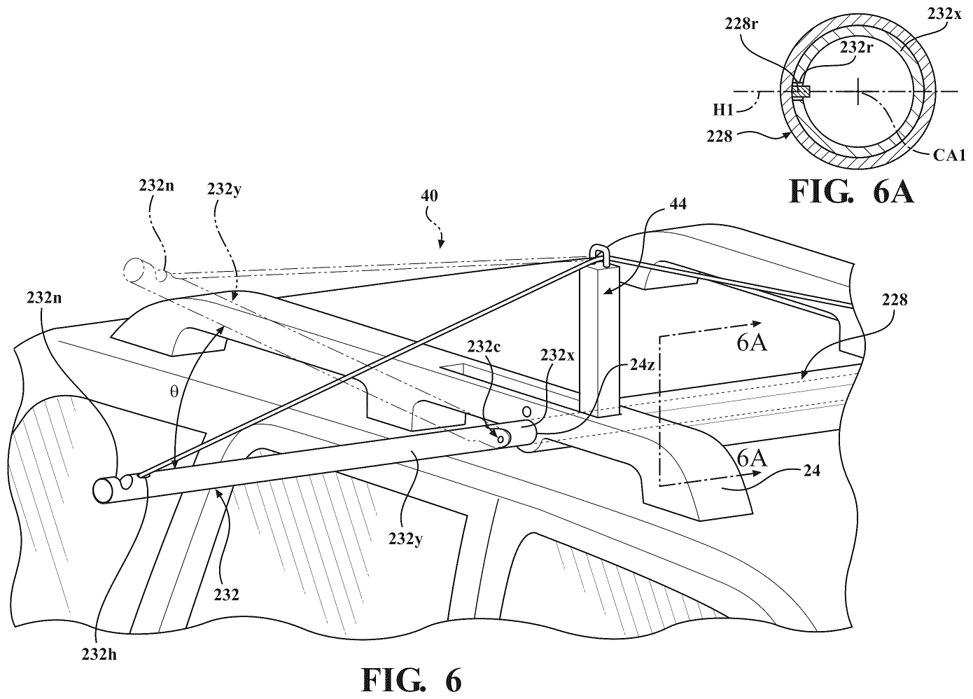

FIG. 6 is a schematic perspective view similar to FIG. 5, showing an alternative embodiment 232 of the boom. In one or more arrangements, the boom 232 includes a first segment 232x and a second segment 232y rotatably connected to the first segment 232x via a hinge mechanism 232c. FIG. 6 shows the second segment 232y deployed from the housing 228 and the first boom passage 24z. Boom first segment 232x resides in the housing 228 to support the hinge mechanism 232c.

In FIG. 6, the hinged version 232 of the boom enables the deployed second segment 232y to be supported at an angle O with respect to a horizontal plane H1 extending through a centroidal axis CA1 of a cross-section of the unloaded boom, when the boom supporting element 40 is connected to the second segment 232y and to the first boom support post 44 and the housing 228 or second roof rail 26 as previously described. This structure enables the height of the object support point above ground G1 to be varied according to the requirements of a particular application.

When the boom first segment 232x is to be deployed to the left-hand side of the vehicle 20, the boom 232 is extended until the hinge mechanism 232c_ and the first segment 232x are outside the housing 228 and the associated second boom passage 26z. The boom supporting element 40 may then be connected to the deployed boom first segment 232x in the same manner as previously described for the boom second segment 232y.

Referring now to FIG. 6A, embodiments of the utility boom assembly including a segmented boom 232 as just described may also incorporate a boom anti-rotation mechanism connected to the boom 232 and structured to prevent rotation of a segment of the boom 232 residing inside the housing 228 when the other segment of the boom is deployed from the housing 228 and an associated boom passage. In one exemplary arrangement, the boom anti-rotation mechanism may include one or extruded more rib(s) 228r extending from portions of an internal wall of the housing 228. The rib(s) 228r may be aligned with each other along a length of the housing wall. One or more complementary slot(s) 232r may be formed in portions of a wall of the boom 232 for slidably receiving housing wall rib(s) 228r therein.

The housing 228 and boom 232 may be structured so that slot(s) 232r slidingly engage associated rib(s) 228r whenever a portion of the boom 232 resides in the housing. When one segment of the boom is deployed, the segment remaining in the housing 228 may be prevented from rotating by engagement between the housing rib(s) 228r and the boom slot(s) 232r. This engagement prevents the deployed portion of the boom 232 from undesirably rotating when the deployed portion of the boom 232 is secured at an angle θ with respect to the horizontal plane H1.

In embodiments of the utility boom assembly described herein, an amount that the deployed boom extends from the vehicle may be varied by a user as needed to support objects (or portions of objects) at various distances from the vehicle and also at various heights with respect to a ground surface.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6A, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A vehicle utility boom assembly comprising:
a first roof rail including a first boom passage;
a second roof rail including a second boom passage and structured to be mounted opposite the first roof rail;
a boom housing structured to connect the first and second boom passages; and
a boom structured to be positionable in the housing so as to be deployable from the housing along a side of the vehicle, through any of the first and second boom passages.

2. The vehicle utility boom assembly of claim 1, further comprising a first boom support post structured to be connected to the first roof rail in a support configuration.

3. The vehicle utility boom assembly of claim 2, wherein the first roof rail defines a first support-receiving cavity, and wherein the first boom support post is rotatably attached to the first roof rail so as to be rotatable between a stowed configuration and the support configuration.

4. The vehicle utility boom assembly of claim 2, further comprising a boom supporting element structured to extend between the boom and the first boom support post, and between the first boom support post and one of the housing and the second roof rail, when the boom is deployed along a first side of the vehicle.

5. The vehicle utility boom assembly of claim 4, wherein the boom supporting element is connected to the one of the housing and the second roof rail by a ratchet mechanism.

6. The vehicle utility boom assembly of claim 1, further comprising a second boom support post structured to be connected to the second roof rail in a support configuration.

7. The vehicle utility boom assembly of claim 6, wherein the second roof rail defines a second support-receiving cavity, and wherein the second boom support post is rotatably attached to the second roof rail so as to be rotatable between a stowed configuration the support configuration of the second boom support post.

8. The vehicle utility boom assembly of claim 1, wherein the boom includes a first segment and a second segment rotatably connected to the first segment and structured to reside outside the housing when the boom is deployed, wherein the second segment is structured to be supportable at an angle with respect to a horizontal plane extending through the boom when the second segment is deployed from the housing.

9. The vehicle utility boom assembly of claim 8, further comprising a boom anti-rotation mechanism connected to the boom and structured to prevent rotation of a portion of the boom residing inside the housing when the boom second segment is deployed.

10. A vehicle comprising a vehicle utility boom assembly in accordance with claim 1.
